(19) United States
(12) Patent Application Publication
(10) Pub. No.: US 2011/0086621 A1
(43) Pub. Date: Apr. 14, 2011

(54) METHOD AND APPARATUS FOR INDICATING OPERATION STATE IN MOBILE TERMINAL

(75) Inventors: In-Gu SON, Gumi-si (KR); Chang-Taek KANG, Suwon-si (KR); Dong-Wook KWON, Yongin-si (KR)

(73) Assignee: SAMSUNG ELECTRONICS CO. LTD., Suwon-si (KR)

(21) Appl. No.: 12/899,785

(22) Filed: Oct. 7, 2010

(30) Foreign Application Priority Data
Oct. 14, 2009 (KR) 10-2009-0097934

(51) Int. Cl. H04M 1/00; H04M 3/42

(52) U.S. Cl. 455/414.1; 455/558

(57) ABSTRACT

A method and apparatus for indicating an operation state in a mobile terminal are provided. The apparatus includes a light emitter (for example, a Light Emitting Diode (LED)) mounted on an exterior of the mobile terminal so that a user can intuitively recognize the mounting or non-mounting of a user identification (ID) card, a primary- or secondary-setting state of a user ID card, or a user ID card associated with an event (transmission or reception of a call, a text message, or data) among a plurality of user ID cards.

### PRIORITY

This application claims the benefit under 35 U.S.C. §119(a) of a Korean patent application filed in the Korean Intellectual Property Office on Oct. 14, 2009 and assigned Serial No. 10-2009-0097934, the entire disclosure of which is hereby incorporated by reference.

### BACKGROUND OF THE INVENTION

1. Field of the Invention

The present invention relates to a method and apparatus for operating a mobile terminal More particularly, the present invention relates to a method and apparatus for indicating an operation state in a mobile terminal.

2. Description of the Related Art

In recent times, mobile terminals have been configured to perform various functions, such as data and voice communication functions, a still-picture or moving-picture photographing function using a camera, a voice storing function, a music-file reproducing function using a speaker system, an image or video display functions, and the like. In particular, multi-mode mobile terminals capable of using two or more communication networks have been recently released in the market. A multi-mode mobile terminal can perform communication in a service area of two or more communication networks. For example, if a multi-mode mobile terminal is a dual-mode mobile terminal which supports a Code Division Multiple Access (CDMA) communication network and a Global System for Mobile communication (GSM) communication network, the dual-mode mobile terminal can perform communication in both a service area of the CDMA communication network and a service area of the GSM communication network. Meanwhile, multi-standby mobile terminals capable of simultaneously supporting two or more communication networks unlike the multi-mode mobile terminal have also been released in the market. For example, if a multi-standby mobile terminal is a dual-standby mobile terminal supporting both a CDMA communication network and a GSM communication network, the dual-standby mobile terminal periodically requests and receives a preamble and/or a pilot channel signal from a base station of the CDMA communication network and a base station of the GSM communication network, and measures a channel state, such as Received Signal Strength Indicator (RSSI), Carrier to Interference-plus-Noise Ratio (CINR), Quality of Service (QoS), or the like, thereby supporting the two communication networks at the same time.

The multi-mode mobile terminal and the multi-standby mobile terminal must have mounted therein at least two or more user identification (ID) cards, e.g., a user ID card for CDMA and a user ID card for GSM. However, because the user ID cards are mounted inside the mobile terminals, it is difficult to determine if they have been actually mounted. Moreover, a user may set one of the two or more user ID cards as a primary card to selectively use it over the other user ID card, but the user may not remember which of the user ID cards is set as the primary card at all times. That is, in the conventional multi-mode mobile terminal and the conventional multi-standby mobile terminal, the user cannot intuitively recognize the mounting or non-mounting of the user ID card in the terminals or a primary- or secondary-setting state of the user ID card.

### SUMMARY OF THE INVENTION

An aspect of the present invention is to address at least the above mentioned problems and/or disadvantages and to provide at least the advantages described below. Accordingly, an aspect of the present invention is to provide a method and apparatus for indicating an operation state in a mobile terminal, by which a user can intuitively recognize mounting or non-mounting of a user ID card, a primary- or secondary-setting state of a user ID card, and a user ID card which interworks with an occurrence of an event.

In accordance with an aspect of the present invention, a method for indicating an operation state in a mobile terminal comprising two or more user identification (ID) cards is provided. The method includes determining whether a first user ID card and a second user ID card are mounted and controlling a light emitter to emit light upon at least one of an occurrence of an event associated with the first user ID card and an occurrence of an event associated with the second user ID card.

According to another aspect of the present invention, an apparatus for indicating an operation state in a mobile terminal comprising two or more user identification (ID) cards is provided. The apparatus includes a first user ID card and a second user ID card to be inserted into the mobile terminal, a light emitter for emitting light at predetermined intervals, with a predetermined color, or with a predetermined brightness, and a controller for controlling the light emitter to emit light according to an event associated with the first user ID card or an event associated with the second user ID card upon occurrence of the associated event.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiment of the present invention will be more apparent from the following detailed description taken in conjunction with the accompanying drawings, in which:

FIG. 1 schematically illustrates an exterior of a dual-standby mobile terminal according to an exemplary embodiment of the present invention;

FIG. 2 is a block diagram of a mobile terminal according to an exemplary embodiment of the present invention;

FIGS. 3A through 3C illustrate screens for setting indication of an operation state according to an exemplary embodiment of the present invention;

FIG. 4 is a flowchart illustrating a method for indicating whether a user identification (ID) card has been mounted, by using a light emitter of a dual-standby mobile terminal according to an exemplary embodiment of the present invention; and

FIG. 5 is a flowchart illustrating a method for indicating an operation state in a dual-standby mobile terminal according to an exemplary embodiment of the present invention.

Throughout the drawings, it should be noted that like reference numbers are used to depict the same or similar elements, features, and structures.

### DETAILED DESCRIPTION OF THE EXEMPLARY EMBODIMENT

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Exemplary embodiments of the present invention disclosed in the specification and in the drawings will be provided in order to assist in describing technical matters of the invention and to facilitate understanding of the invention, rather than to limit the scope of the invention. In addition, it would be obvious to those of ordinary skill in the art that other modified embodiments based on the technical spirit of the invention as well as the embodiments disclosed herein can also be implemented.

A mobile terminal according to exemplary embodiments of the present invention may be a multi-mode mobile terminal which separately accesses communication networks of at least two communication schemes or at least two common carriers, or a multi-standby mobile terminal which simultaneously accesses such communication networks. In the following description, for sake of convenience, a dual-standby mobile terminal will be used as an example of the mobile terminal according to an exemplary embodiment of the present invention. The dual-standby mobile terminal simultaneously accesses two communication networks selected from among a plurality of communication schemes such as Code Division Multiple Access (CDMA), Global System for Mobile telecommunication (GSM), Wideband Code Division Multiple Access (WCDMA), Wireless broadband (Wibro), and so forth, or especially in Korea, simultaneously accesses two communication networks selected from among a plurality of common carriers such as SK Telecom (SKT), Korean Telecom Freetel (KTF), LG Telecom (LGT), and the like.

In the following description, a “Subscriber Identification Module (SIM)” refers to a device which stores user authentication information for using a particular wireless communication network. The user ID card may be a SIM, a Universal SIM (USIM), a User Identification Module (UIM), and the like.

In the following description, a “primary” refers to a user ID card which is set to be primarily used by a user among two or more user ID cards when call origination or text message origination is requested.

In the following description, a “secondary” refers to a user ID card which is not set as the primary among two or more user ID cards.

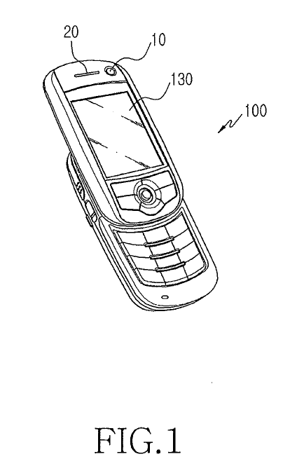

FIG. 1 schematically illustrates an exterior of a dual-standby mobile terminal according to an exemplary embodiment of the present invention.

Referring to FIG. 1, the dual-standby mobile terminal 100 is of a slide type, and may include a first user ID card and a second user ID card. More particularly, the dual-standby mobile terminal 100 may include a light emitter 10 at a side of an upper portion of a body on which a display unit 130 is mounted, for example, beside a speaker 20.

The light emitter 10 may interwork with the first user ID card and the second user ID card. The light emitter 10 is mounted to be exposed to the outside, so that it allows a user to intuitively recognize an operation state in the dual-standby mobile terminal 100. That is, the light emitter 10 allows a user to recognize the mounting or non-mounting of a user ID card, a primary- or secondary-setting state of a user ID card, and a user ID card associated with an occurring event among a plurality of user ID cards. The light emitter 10 may be a Light Emitting Diode (LED). More particularly, the light emitter 10 may be a color LED, for example, a seven-color LED, capable of emitting light in two or more colors to distinguish primary- and secondary-setting states of a user ID card with colors of emitted light.

Alternatively, the light emitter 10 may be formed to emit light in various colors by combining a plurality of LEDs emitting light of different colors. For example, a first LED may emit light in red (R) a second LED may emit light in green (G), and a third LED may emit light in blue (B). In this case, combinations of these LEDs may be a combination of the first LED and the second LED, a combination of the second LED and the third LED, and a combination of the third LED and the first LED. Each of the combinations may also be combined with the other LED to express various colors.

In an exemplary implementation, the dual-standby mobile terminal 100 turns ON the light emitter 10 when the first user ID card or the second user ID card is mounted, and indicates whether or not the first user ID card or the second user ID card has been mounted, by a flickering time (e.g., a flickering interval), a color of emitted light, a brightness of the emitted light, and so forth.

The dual-standby mobile terminal 100 may be adapted such that the light emitter 10 flickers at short time intervals upon occurrence of an event associated with the first user ID card, whereas the light emitter 10 flickers at long time intervals upon occurrence of an event associated with the second user ID card.

To distinguish the primary- and secondary-setting states of the user ID card with colors of light emitted from the light emitter 10, the dual-standby mobile terminal 100 may be adapted such that the light emitter 10 emits light of a first color (e.g., green) if the user sets the first user ID card as a primary and emits light of a second color (e.g., red) which is visually distinct from the first color if the user sets the second user ID card as the primary.

To distinguish the primary- and secondary-setting states of the user ID card based on the brightness of emitted light of the light emitter 10, the dual-standby mobile terminal 100 may be adapted such that the light emitter 10 emits light of a first brightness (e.g., a maximum brightness of the light emitter 10) if the user sets the first user ID card as the primary and emits light of a second brightness (e.g., a brightness of 40% of the maximum brightness) which is darker than the first brightness if the user sets the second user ID card as the primary. In this way, the user can intuitively recognize mounting or non-mounting of the user ID card, the primary- or secondary-setting state of the user ID card, and the user ID card associated with an occurring event.

While the dual-standby mobile terminal 100 has been briefly described, the present invention is not limited thereto. In other words, it is obvious that the dual-standby mobile terminal 100 according to an embodiment of the present invention may be of various types, such as a folder type, a bar type, and the like, and a flickering time, a color of emitted light, and a brightness of emitted light for indicating whether or not a user ID card has been mounted, a primary- or secondary-setting state, and a user ID card associated with an occurring event are subject to change according to user's setting or default setting of the dual-standby mobile terminal 100.

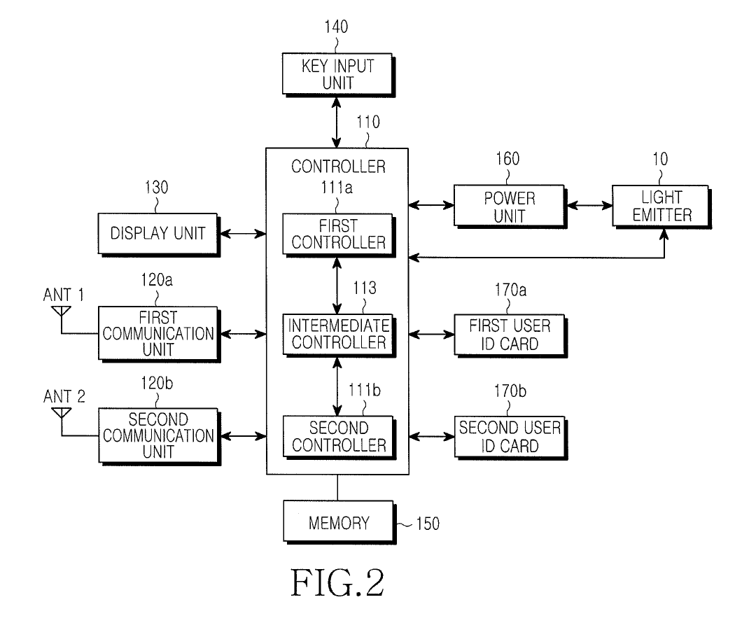

The foregoing description has been made regarding the dual-standby mobile terminal 100 according to an exemplary embodiment of the present invention. Now, components of the dual-standby mobile terminal 100 will be described in more detail with reference to FIG. 2.

FIG. 2 is a block diagram of a mobile terminal according to an exemplary embodiment of the present invention.

Referring to FIG. 2, the dual-standby mobile terminal 100 includes a first communication unit 120a, a second communication unit 120b, a display unit 130, a key input unit 140, a memory 150, a power supply unit 160, a first user ID card 170a, a second user ID card 170b, a light emitter 10, and a control unit 110.

The first communication unit 120a and the second communication unit 120b are Radio Frequency (RF) units for performing a wireless communication function. Each of the first communication unit 120a and the second communication unit 120b includes an RF transmitter for up-converting a frequency of a transmission signal and amplifying the transmission signal, an RF receiver for low-noise amplifying a reception signal and down-converting a frequency of the reception signal, antennas (e.g., ANT1 and ANT2) for electric wave transmission/reception, and a duplexer for classifying and processing electric waves transmitted/received through the antennas.

The first communication unit 120a is an RF unit for accessing a communication network of a first communication scheme/first common carrier (for example, a first communication network), and the second communication unit 120b is an RF unit for accessing a communication network of a second communication scheme/second common carrier (for example, a second communication network). If the first communication scheme is GSM and the second communication scheme is CDMA, the first communication unit 120a and the second communication unit 120b perform wireless transmission and wireless reception according to relevant protocols to use the GSM network and the CDMA network, respectively. If the first common carrier is SKT and the second common carrier is KTF, the first communication unit 120a and the second communication unit 120b perform wireless transmission and wireless reception according to relevant protocols to use the SKT network and the KTF network, respectively.

The display unit 130 visually displays various information associated with a state and an operation of the dual-standby mobile terminal 100. The display unit 130 may be implemented with various display devices such as a Liquid Crystal Display (LCD), an Organic Light Emitting Diode (OLED), a Plasma Display Panel (PDP), and the like. The display unit 130 may display an icon for indicating an operation state in the dual-standby mobile terminal 100, that is, an icon corresponding to the first user ID card 170a and an icon corresponding to the second user ID card 170b at a side thereof. More particularly, the display unit 130 according to an exemplary embodiment of the present invention may display a menu screen for setting a function to indicate the operation state in the dual-standby mobile terminal 100 by using the light emitter 10, under the control of a first controller 111a.

A key input unit 140 receives a user's manipulation signal for controlling the operation of the dual-standby mobile terminal 100. The key input unit 140 may perform manipulation of an input for setting a flickering time, a color of emitted light, and a color of the emitted light according to an exemplary embodiment of the present invention.

The memory 150 stores programs and information required for the operation of the dual-standby mobile terminal 100. The memory 150 also stores programs and data required for accessing the communication network of the first communication scheme/first common carrier set for the first communication unit 120a and the communication network of the second communication scheme/second common carrier set for the second communication unit 120b. Although the single memory 150 is shown in FIG. 2, the present invention is not limited thereto. For example, the memory 150 may include a first memory unit and a second memory unit which store programs and data required for accessing the communication networks set for the first communication unit 120a and the second communication unit 120b, respectively. The first memory unit and the second memory unit may be controlled by the first controller 111a and a second controller 111b, respectively.

The first user ID card 170a and the second user ID card 170b, which are dual-standby mode smart cards, can simultaneously support, for example, a GSM mode and a CDMA mode, or SKT and KTF. If the first user ID card 170a and the second user ID card 170b are smart cards for supporting the GSM mode and the CDMA mode, respectively, data associated with the GSM mode and data associated with the CDMA mode are stored therein, respectively. Such data includes subscriber information and authentication information used for GSM communication and CDMA communication, and may include record information associated with wireless communication.

Data of the first user ID card 170a and the second user ID card 170b are managed by a file system including a Primary File (PF), a Dedicated File (DF), and an Elementary File (EF). The PF corresponds to a root file. The DF is a file corresponding to a subdirectory of the PF and corresponding to a service for supporting a function required by telecom service, GSM, and CDMA. The DF includes a plurality of EFs which store data utilized in each service. The EF is any file required for execution of an application file of each DF. The EF stores subscriber information such as a subscriber's phone number, a communication charge, and frequently used phone numbers, authentication information, and the like.

The first user ID card 170a and the second user ID card 170b are inserted into a card connector (not shown) which provides an interface to be controlled by a first controller 111a and a second controller 111b described below. That is, the first user ID card 170a and the second user ID card 170b transmit input and output signals through the card connector under the control of the first controller 111a and the second controller 111b, respectively. The card connector includes slots (for example, first and second slots) into which the first user ID card 170a and the second user ID card 170b are inserted, thereby allowing mounting and dis-mounting of the first user ID card 170a and the second user ID card 170b.

The control unit 110 controls the overall operation of each component of the dual-standby mobile terminal 100. The control unit 110 includes the first controller 111a, the second controller 111b, and an intermediate processor 113. If the first user ID card 170a is set to the GSM mode and the second user ID card 170b is set to the CDMA mode, the first controller 111a controls the GSM mode and the second controller 111b controls the CDMA mode. Each of the first controller 111a and the second controller 111b may include a wireless communication microcontroller chip. Each of the first controller 111a and the second controller 111b may include a data processing module which has a modem and a codec. The codec may include a data codec for processing packet data and an audio codec for processing an audio signal such as a speech signal. A signal to be transmitted through the first communication unit 120a and the second communication unit 120b is coded and modulated and a signal to be received through the first communication unit 120a and the second communication unit 120b is demodulated and decoded by the first controller 111a and the second controller 111b.

The first controller 111a may control the overall operation of the dual-standby mobile terminal 100 and a flow of signals between internal blocks of the dual-standby mobile terminal 100. That is, the first controller 111a may be a main controller. More particularly, the first controller 111a may control an operation of the light emitter 10 such that the user can intuitively recognize an operation state in the dual-standby mobile terminal 100 through the light emitter 10 exposed to the outside.

The first controller 111a may turn ON or OFF the light emitter 10 by determining the mounting or non-mounting of the first user ID card 170a based on whether a communication channel with the first user ID card 170a has been formed. The first controller 111a may turn ON or OFF the light emitter 10 by receiving information about the mounting or non-mounting of the second user ID card 170b through the intermediate processor 113.

The first controller 111a may control the brightness or color of emitted light from the light emitter 10 by checking a primary- or secondary-setting state of the first user ID card 170a or the second user ID card 170b.

The first controller 111a may control the light emitter 10 to flicker at predetermined flickering intervals during a predetermined time if an event associated with the first user ID card 170a, e.g., transmission or reception of a call, a text message, or data, occurs through the first communication unit 120a. The first controller 111a may control the light emitter 10 to flicker at predetermined flickering intervals during a predetermined time if an event associated with the second user ID, e.g., transmission or reception of a call, a text message, or data, occurs through the second communication unit 120b.

The second controller 111b is a secondary controller of the dual-standby mobile terminal 100, and may perform a communication function with another mobile terminal by using the second communication unit 120b. More particularly, the second controller 111b may determine the mounting or non-mounting of the second user ID card 170b and transmit information about the mounting or non-mounting of the second user ID card 170b to the first controller 111a through the intermediate processor 113. The second controller 111b may transmit an event associated with the second user ID card 170b, e.g., transmission or reception of a call, a text message, or data, to the first controller 111a through the intermediate processor 113 if the event occurs through the second communication unit 120b.

The intermediate processor 113 provides an interface for mutual communication between the first controller 111a and the second controller 111b. More particularly, if an event associated with the second user ID card 170b, i.e., transmission or reception of a call, a text message, or data, occurs under the control of the second controller 111b, the intermediate processor 113 may transmit the event to the first controller 111a and transmit information about the mounting or non-mounting of the second user ID card 170b to the first controller 111a.

The power supply unit 160 is a device for supplying power to the light emitter 10. The power supply unit 160 may be a Low Drop Output (LDO) which outputs a specific voltage under the control of the control unit 110.

The light emitter 10 is a device for emitting light when power is supplied. The light emitter 10 may be a Light Emitting Diode (LED). More particularly, when a primary- or secondary-setting state of a user ID card is indicated by a color of emitted light of the light emitter 10, the light emitter 10 may be a color LED which emits light in at least two or more colors. The light emitter 10 may operate in association with the first user ID card 170a and the second user ID card 170b. More specifically, the light emitter 10 is turned ON when the first user ID card 170a is mounted in a first slot and the second user ID card 170b is mounted in a second slot, and is turned OFF when they are not mounted. In other words, the user can intuitively recognize whether the first user ID card 170a and the second user ID card 170b are mounted, according to the ON/OFF states of the light emitter 10.

When the first communication unit 120a transmits or receives a call, a text message, or data, that is, when an event associated with the first user ID card 170a occurs, the light emitter 10 may perform a flickering operation at predetermined flickering intervals during a predetermined time. Hence, the user can recognize that transmission or reception of a call request, a text message, or data are performed through the first communication unit 120a. When the second communication unit 120b transmits or receives a call, a text message, or data, that is, when an event associated with the second user ID card 170b occurs, the light emitter 10 may perform a flickering operation at predetermined flickering intervals during a predetermined time. Hence, the user can recognize that transmission or reception of a call request, a text message, or data are performed through the second communication unit 120b. Of course, the predetermined flickering intervals associated with transmission or reception of calls, text messages, or data by the first user ID card 170a or the second user ID card 170b may differ.

When a primary- or secondary-setting state of a user ID card is indicated by a color of emitted light of the light emitter 10, the light emitter 10 may emit light in a predetermined color according to a primary- or secondary-setting state of the user ID card (for example, in green for a primary and in red for a secondary). When a primary- or secondary-setting state of a user ID card is indicated by a brightness of emitted light of the light emitter 10, the light emitter 10 may emit light with a predetermined brightness according to a primary- or secondary-setting state of the user ID card. For example, the light emitter 10 may emit light with a first brightness (100%) for the first user ID card 170a set as a primary and with a second brightness (40%) for the first user ID card 170a set as a secondary. In other words, the user can intuitively recognize the primary- or secondary-setting state of each of the first user ID card 170a and the second user ID card 170b from the color or brightness of emitted light of the light emitter 10.

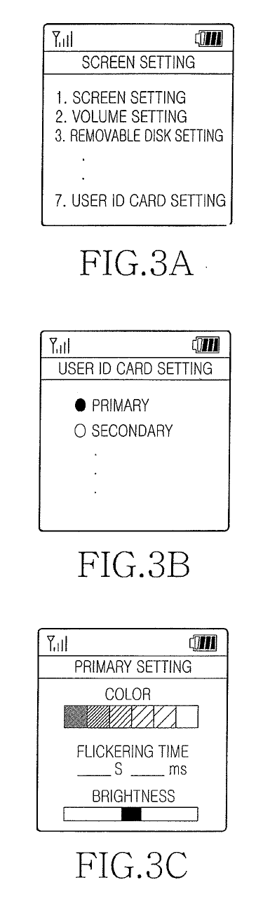

FIGS. 3A through 3C illustrate screens for setting indication of an operation state according to an exemplary embodiment of the present invention.

Once the user presses a menu button on a standby screen state of the dual-standby mobile terminal 100, the dual-standby mobile terminal 100 provides an environment setting screen as shown in FIG. 3A. If the user selects an operation state indication setting menu corresponding to a user ID card, for example, “7. user ID card setting,” the dual-standby mobile terminal 100 provides a screen as shown in FIG. 3B. If the user selects a primary or secondary user ID card to set indication of an operation state corresponding to a user ID card, the dual-standby mobile terminal 100 provides a screen as shown in FIG. 3C. If the user sets a color, a flickering time, a brightness or the like to indicate an operation state in the selected user ID card in FIG. 3C, the dual-standby mobile terminal 100 stores the setting. More particularly, to indicate the operation state in the user ID card, one or more selections may be made among a color, a flickering time, and a brightness.

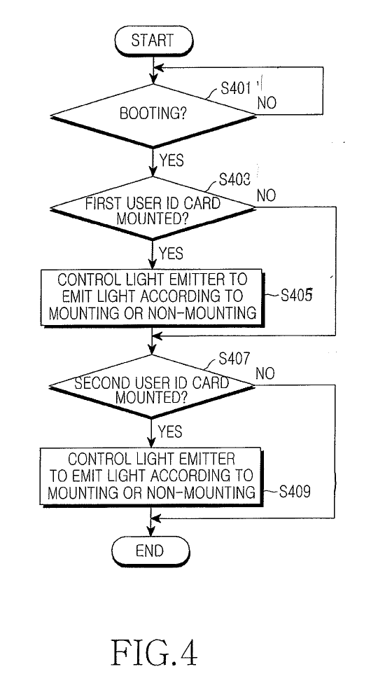

FIG. 4 is a flowchart illustrating a method for indicating mounting or non-mounting of a user ID card by using a light emitter of a dual-standby mobile terminal according to an exemplary embodiment of the present invention.

Referring to FIGS. 2 and 4, the dual-standby mobile terminal 100 determines if a booting process is performed in step S401. If it is determined in step S401 that a booting process is performed, the first controller 111a determines whether the first user ID card 170a has been mounted in the first slot in step S403. The mounting or non-mounting of the first user ID card 170a may be determined based on whether a communication channel between the first user ID card 170a and the first controller 111a has been formed. The dual-standby mobile terminal 100 may further include a circuit for transmitting an interrupt signal to the first controller 111a when the first user ID card 170a is mounted, and the first controller 111a may determine that the first user ID card 170a is mounted through the received interrupt signal.

If the first controller 111a determines in step S403 that the first user ID card 170a has been mounted in the first slot, the first controller 111a proceeds to step S405 to turn ON the light emitter 10 and control the turned-ON emitter 10 to emit light with a color, a flickering time, a brightness, or the like corresponding to mounting of the first user ID card 170a.

Thereafter, the second controller 111b may determine in step S407 whether the second user ID card 170b has been mounted in the second slot. The mounting or non-mounting of the second user ID card 170b may be determined based on whether a communication channel between the second controller 111b and the second user ID card 170b has been formed. The dual-standby mobile terminal 100 may further include a circuit for transmitting an interrupt signal to the second controller 111b when the second user ID card 170b is mounted, and the second controller 111b may determine that the second user ID card 170b is mounted through the received interrupt signal.

If the second controller 111b determines in step S407 that the second user ID card 170b has been mounted in the second slot, the second controller 111b proceeds to step S409 to turn ON the light emitter 10 and control the turned-ON emitter 10 to emit light with a color, a flickering time, a brightness, or the like corresponding to mounting of the second user ID card 170b.

A way to control the light emitter 10 to emit light in step S409 when the second user ID card 170b is mounted in the second slot in step S407 is substantially similar to step S405. That is, the second controller 111b turns ON the light emitter 10 and controls the turned-ON emitter 10 to emit light with a color, a flickering time, or a brightness corresponding to mounting of the second user ID card 170b.

As described above, the user can intuitively recognize mounting or non-mounting of the first user ID card 170a or the second user ID card 170b from the light emitter 10 of the dual-standby mobile terminal 100 exposed to the outside.

Although it is described in FIG. 4 that mounting and non-mounting of the first user ID card 170a and the second user ID card 170b are determined during a booting process, the present invention is not limited thereto. In other words, such a determination may be performed in a standby state after completion of booting or if there is a user input indicating user's intention to determine the mounting or non-mounting of the first user ID card 170a and the second user ID card 170b.

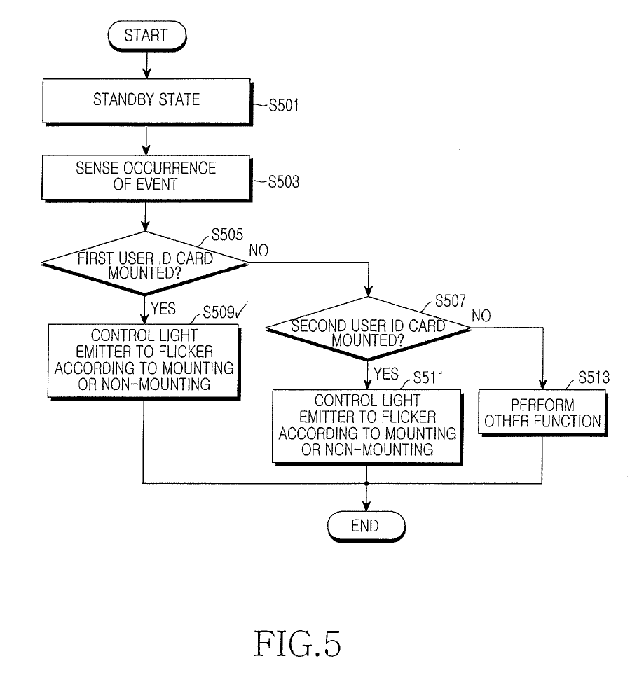

FIG. 5 is a flowchart illustrating a method for indicating an operation state in a dual-standby mobile terminal according to an exemplary embodiment of the present invention.

Referring to FIG. 5, the first controller 111a may be in a standby state in step S501. In step S503, the first controller 111a may sense an occurrence of an event. In step S505, the first controller 111a determines if the event occurring in step S503 is an event associated with the first user ID card 170a. If the first controller 111a determines that the event occurring in step S503 is an event associated with the first user ID card 170a, the first controller 111a may proceeds to step S509 to control the light emitter 10 to flicker at first flickering intervals during a predetermined time. The event associated with the first user ID card 170a may be transmission or reception of a call, a text message, or data. On the other hand, if the first controller 111a determines that the event occurring in step S503 is not an event associated with the first user ID card 170a, the first controller 111a may proceed to step S507. In step S507, the second controller 111b determines whether the event occurring in step S503 is associated with the second user ID card 170b. The occurrence of the event associated with the second user ID card 170b may be notified by the second controller 111b through the intermediate communication processor 113. If it is determined that the event is associated with the second user ID card 170b in step S507, the second controller 111b may proceed to step S511 to control the light emitter 10 to flicker at second flickering intervals during a predetermined time. The event associated with the second user ID card 170b may be transmission or reception of a call, a text message, or data through the second communication unit 120b. On the other hand, if it is determined that the event is not associated with the second user ID card 170b in step S507, the process proceeds to step S513 to perform another function.

Thereafter, if the event is terminated, the method of indicating the operation state in the dual-standby mobile terminal 100 may be terminated.

While it is described that the event occurring at flickering intervals of the light emitter is an event associated with the first user ID card 170a (for example, SIM1) or an event associated with the second user ID card 170b (for example, SIM2) to indicate the operation state in the mobile terminal in the foregoing description, this description is merely used in a general sense to facilitate description and understanding of the technical matter of the present invention, and the present invention is not limited to the foregoing embodiment. For example, the operation state in the mobile terminal may be stored as shown in Table 1 to control the light emitter 10 to emit light with flickering intervals/brightness/color corresponding to the operation state.

TABLE 1

| | | SIM1 | SIM2 |
|---|---|---|---|
| Flickering | Mounting | First flickering | Second flickering |
| intervals | | intervals | intervals |
| | Call | Third flickering | Fourth flickering |
| | | intervals | intervals |
| | Message | Fifth flickering | Sixth flickering |
| | | intervals | intervals |
| | Data | Seventh flickering | Eighth flickering |
| | | intervals | intervals |
| Brightness | Mounting | First brightness | Second brightness |
| | Call | Third brightness | Fourth brightness |
| | Message | Fifth brightness | Sixth brightness |
| | Data | Seventh | Eighth brightness |
| | | brightness | |
| Color | Mounting | First color (green) | Second color (red) |
| | Call | Third color | Fourth color |
| | Message | Fifth color | Sixth color |
| | Data | Seventh color | Eighth color |

Referring to Table 1, the dual-standby mobile terminal 100 controls the light emitter 10 to emit light in a predetermined first color (for example, green) if the first user ID card 170a is mounted, and to emit light in a color visually distinct from the first color (e.g., red) if the second user ID card 170b is mounted. The dual-standby mobile terminal 100 also controls the light emitter 10 to emit light with a predetermined brightness (for example, a first brightness, a third brightness, a fifth brightness, or a seventh brightness) when transmission or reception of a call, a text message, or data associated with the first user ID card 170a occurs, and to emit with a predetermined brightness (e.g., a second brightness, a fourth brightness, a sixth brightness, or an eighth brightness) when transmission or reception of a call, a text message, or data associated with the second user ID card 170b occurs.

As can be appreciated from the foregoing description, a user can intuitively recognize an operation state in the mobile terminal through the light emitter exposed to the outside, that is, the mounting or non-mounting of the user ID card, the primary- or secondary-setting state of the user ID card, and the user ID card associated with an event such as transmission or reception of a call, a text message, or data among a plurality of user ID cards, thereby improving user convenience.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method for indicating an operation state in a mobile terminal comprising two or more user identification (ID) cards, the method comprising:
determining whether a first user ID card and a second user ID card are mounted; and
controlling a light emitter to emit light upon at least one of an occurrence of an event associated with the first user ID card and an occurrence of an event associated with the second user ID card.

2. The method of claim 1, wherein the event associated with the first user ID card or the event associated with the second user ID card comprises at least one of transmission or reception of a call, a text message, or data through the first user ID card or the second user ID card, and a change of a setting state of the first user ID card or the second user ID card into a primary or a secondary.

3. The method of claim 2, wherein the controlling of the light emitter comprises at least one of:
controlling the light emitter to flicker during a predetermined time at predetermined intervals corresponding to the classified event associated with the first user ID card or the second user ID card;
controlling the light emitter to emit light in a color corresponding to the classified event associated with the first user ID card or the second user ID card; and
controlling the light emitter to emit light with a brightness corresponding to the classified event associated with the first user ID card or the second user ID card.

4. The method of claim 3, wherein the controlling of the light emitter to flicker comprises:
upon occurrence of the event associated with the first user ID card, controlling the light emitter to flicker during the predetermined time corresponding to the event associated with the first user ID card; and
upon occurrence of the event associated with the second user ID card, controlling the light emitter to flicker during the predetermined time corresponding to the event associated with the second user ID card.

5. The method of claim 4, wherein the predetermined time corresponding to the event associated with the first user ID card differs from the predetermined time corresponding to the event associated with the second user ID card.

6. The method of claim 3, wherein the indicating of the light emitter with a color comprises:
upon occurrence of the event associated with the first user ID card, controlling the light emitter to emit light in a predetermined color corresponding to the classified event associated with the first user ID card; and
upon occurrence of the event associated with the second user ID card, controlling the light emitter to emit light in a predetermined color corresponding to the classified event associated with the first second ID card.

7. The method of claim 6, wherein the predetermined color corresponding to the classified event associated with the first user ID card differs from the predetermined color corresponding to the classified event associated with the second user ID card.

8. The method of claim 3, wherein the indicating of the light emitter with a brightness comprises:
upon occurrence of the event associated with the first user ID card, controlling the light emitter to emit light with a brightness corresponding to the classified event associated with the first user ID card; and
upon occurrence of the event associated with the second user ID card, controlling the light emitter to emit light with a brightness corresponding to the classified event associated with the second user ID card.

9. The method of claim 8, wherein the brightness corresponding to the classified event associated with the first user ID card differs from the brightness corresponding to the classified event associated with the second user ID card.

10. The method of claim 1, wherein the light emitter is turned ON or OFF according to whether the first user ID card or the second user ID card is mounted.

11. An apparatus for indicating an operation state in a mobile terminal comprising two or more user identification (ID) cards, the apparatus comprising:
a first user ID card and a second user ID card to be inserted into the mobile terminal;
a light emitter for emitting light at predetermined intervals, with a predetermined color, or with a predetermined brightness; and
a controller for controlling the light emitter to emit light according to an event associated with the first user ID card or an event associated with the second user ID card upon occurrence of the associated event.

12. The apparatus of claim 11, wherein the event associated with the first user ID card or the event associated with the second user ID card comprises at least one of transmission or reception of a call, a text message, or data through the first user ID card or the second user ID card, and a change of a setting state of the first user ID card or the second user ID card into a primary or a secondary.

13. The apparatus of claim 12, wherein the controller controls the light emitter to flicker during a predetermined time at predetermined intervals corresponding to the classified event associated with the first user ID card or the second user ID card;
controls the light emitter to emit light in a color corresponding to the classified event associated with the first user ID card or the second user ID card; or
controls the light emitter to emit light with a brightness corresponding to the classified event associated with the first user ID card or the second user ID card.

14. The apparatus of claim 13, wherein the controller controls the light emitter to flicker during the predetermined time corresponding to the event associated with the first user ID card upon occurrence of the event associated with the first user ID card; and
controls the light emitter to flicker during the predetermined time corresponding to the event associated with the second user ID card upon occurrence of the event associated with the second user ID card.

15. The apparatus of claim 14, wherein the predetermined time corresponding to the event associated with the first user ID card differs from the predetermined time corresponding to the event associated with the second user ID card.

16. The apparatus of claim 13, wherein the controller controls the light emitter to emit light in a predetermined color corresponding to the classified event associated with the first user ID card upon occurrence of the event associated with the first user ID card; and
controls the light emitter to emit light in a predetermined color corresponding to the classified event associated with the first second ID card upon occurrence of the event associated with the second user ID card.

17. The apparatus of claim 16, wherein the predetermined color corresponding to the classified event associated with the first user ID card differs from the predetermined color corresponding to the classified event associated with the second user ID card.

18. The apparatus of claim 13, wherein the controller controls the light emitter to emit light with a brightness corresponding to the classified event associated with the first user ID card upon occurrence of the event associated with the first user ID card; and
controls the light emitter to emit light with a brightness corresponding to the classified event associated with the second user ID card upon occurrence of the event associated with the second user ID card.

19. The apparatus of claim 18, wherein the brightness corresponding to the classified event associated with the first user ID card differs from the brightness corresponding to the classified event associated with the second user ID card.

20. The apparatus of claim 11, wherein the controller turns ON or OFF according to whether the first user ID card or the second user ID card is mounted.
